(19) United States
(12) Patent Application Publication
(10) Pub. No.: US 2015/0217299 A1
(43) Pub. Date: Aug. 6, 2015

(54) DISINTEGRATING DEVICE

(71) Applicant: Doppstadt Familienholding GmbH, Velbert (DE)

(72) Inventors: Johann Doppstadt, Velbert (DE); Horst Berger, Calbe (DE)

(21) Appl. No.: 14/419,069

(22) PCT Filed: Jul. 22, 2013
(86) PCT No.: PCT/EP2013/065424

§ 371 Date: Feb. 2, 2015

(30) Foreign Application Priority Data
Aug. 3, 2012 (DE) 20 2012 007 418.0

(51) Int. Cl. B02C 18/14; B02C 18/20

(52) U.S. Cl. CPC B02C 18/145; B02C 18/20; B02C 2018/162

(57) ABSTRACT

The invention relates to a disintegrating device, comprising a machine housing, which can be installed on an installation plane or an installation surface, and at least one disintegrating roller. The disintegrating rollers is rotatably supported in the machine housing and has at least one disintegrating tool arranged thereon, at least one counter blade, which interacts with the disintegrating tool, and at least one comb carrier on at least one wall of the machine frame extending parallel to the axis of rotation of the disintegrating roller. The invention is characterized in that at least part of the wall of the machine housing forms a common, in particular pivotable assembly together with the comb carrier.

The invention relates to a disintegrating device, consisting of at least one disintegrating roller supported rotatably in a machine housing with at least one disintegrating tool arranged thereon with at least one counter blade interacting with the disintegrating tool, and with at least one comb carrier provided at least at one wall of the machine frame extending parallel to the rotational axis of the disintegrating roller.

### BACKGROUND OF THE INVENTION

Disintegrating devices of this kind are sufficiently known in the state of the art, for example from the citations DE 83 31 826 U1, DE 20 2008 006 802 U1, and WO 2010/032 037 A1. The rather poor accessibility of the disintegrating roller is a problem during cleaning and maintaining, in particular also during a necessary change of disintegrating tools. The service person often has to bend from above into the housing and turn the roller accordingly in order to reach the disintegrating tools. If tools and/or counter blades are worn they have to be dismantled rather time-consuming. In particular the poor access of the roller and the thus required switching off of the machine for safety reasons in order to avoid a hazard for the employees, means labour that can influence the stand-still times of the machine considerably, and in particular increases the amount of manual operations clearly. This is also the case in different grades of difficulty for the solutions of the state of the art mentioned in the beginning.

In the preceding application DE 20 2006 006 802 U1 the applicant has already suggested that at least the comb plate can be removed from the housing as a common element. However, this does not guarantee an easy access to the roller either, in particular in the bottom area that is not visible or not accessible.

### BRIEF SUMMARY OF THE INVENTION

Referring to this state of the art it is a problem of the invention to remove at least one of the before described disadvantages of the solutions of the state of the art.

The invention refers to the before described state of the art, and suggests for solving the problem a disintegrating device consisting of a machine housing that can be installed on an installation plane and/or installation surface, at least one disintegrating roller rotatably supported in the machine housing with at least one disintegrating tool arranged thereon, with at least one counter blade interacting with the disintegrating tool, and with at least one comb carrier provided on at least one wall of the machine housing extending parallel to the rotational axis of the disintegrating roller, characterized in that at least a part of the wall of the machine housing forms a common, in particular pivotable assembly along with the comb carrier. Already creating a common assembly of machine housing and/or a wall of the machine housing with the comb carrier is an essential improvement compared with the solution of the state of the art as now wall and comb carrier can swing out of the plane of the machine housing commonly. For this the common assembly is configured as pivotable assembly. Without any additional machine effort it will become possible to swing the at least one wall outwards and thus to allow access to the comb and in particular also to the disintegrating roller during servicing. This is very easily possible for a dimension of the disintegrating device that may have a rather small construction size up to a size that corresponds with the size of a large truck or coach. The accessibility, in particular of the machine and in particular of the roller, has been improved. The tools can easily be exchanged in order to reach knives that are arranged concealed without the service person having to move or bend in a dangerous way. A free access of the interior of the disintegrating device is also made possible by pivoting the common assembly for the case of swinging it outwards, what the state of the art does not provide in this way. There counter tools have to be overcome or they have to be dismantled for safety reasons. This increases the effort for maintenance. These disadvantages do not appear anymore in the solution according to the invention.

When the disintegrating roller is driven without electrical power, what is, as a rule, required in order to give the service persons access, it is now easier to reach all disintegrating tools without any problems.

Accordingly already this first modification of the invention solves the problem to remove at least one disadvantage of the state of the art.

An advantageous development of the invention provides that the common assembly is configured such that it can swing away from the disintegrating roller and/or the machine frame outward and back inward. For this purpose a suitable pivot axis is positioned in the wall of the machine housing, through which the common assembly can be pivoted. It is an advantage here when the common assembly can be pivoted out of the plane of the wall up to an angle of 120°, preferably up to 90° with respect to the rotational axis of the disintegrating roller. The pivot axis is here orientated preferably vertically, provided or arranged in particular at an angle of 90° with respect to the installation plane and/or installation surface of the machine housing. When the result is an opening angle of 90° with respect to the horizontally arranged rotational axis of the disintegrating roller, it is possible without any problems to reach all disintegrating tools, no matter whether they are at the counter blade and/or the counter cutting tool or on the disintegrating roller.

Another advantageous modification of the invention, that can be, of course, employed in connection with the before described embodiments of the invention, is characterized in that the common assembly is built module-like, and comprises preferably the wall, the comb carrier, the counter blade, a frame for the comb carrier as well as a locking unit as modules. Of course, the module-like configuration makes maintenance easier as, if necessary, suitable modules can be supplied in order to exchange them for damaged or worn elements easily and quickly. This increases again the ease of repair and maintenance.

It has been found, according to the invention, to be an advantage when the common assembly also comprises a screening device encircling in the swung-in position of the assembly the disintegrating roller at least in sections in a defined, preferably changeable distance. It is the advantage of the solution according to the invention that the solution can be employed either with or without a screening device. Of course, this increases considerably the field or the chances of application of the disintegrating device according to the invention.

Furthermore it is an advantage when the screening device is arranged at the comb carrier. This makes it possible either to complete it, if necessary, for certain application purposes, and/or change or remove it directly so that the device can even be used without the screening device.

Advantageously the comb carrier comprises here a comb carrier shaft arranged at the frame. Thus the entire screening device could be removed along with the combs and the shaft from the waif of the machine housing without the machine as a whole becoming unusable. In fact the reverse is the case. Now it can be used very well without the screening device. Of course, also the entire assembly can be exchanged by inserting a screening device for example with other combs.

The invention is also characterized in that several counter blades form a counter comb attached to a joint of the comb carrier that again is provided at the comb carrier shaft. The counter blades interact with the blades and/or knives on the disintegrating roller and thus form a counter comb provided advantageously at the comb carrier shaft. Thus it can be exchanged completely along with the comb carrier shaft. Of course, the invention also provides that the counter blades can be exchanged individually at the comb carrier shaft.

It is also an advantage when the entire screening device is provided at the horizontally orientated comb carrier shaft, pivotable preferably along with the joint. Thus, of course, the screening device can be positioned or arranged depending on the material to be disintegrated and screened in differing distance from the disintegrating roller with the disintegrating tools. It is another advantage here when the comb carrier is arranged at the frame releasably/fixedly.

The pivot unit for swinging out the entire assembly is provided preferably as hydraulic cylinder swinging out or in the common assembly via a pivot axis orientated vertically seen in mounting direction out of the wall plane of the machine frame. This increases further the ease of operating the disintegrating device according to the invention. By providing a hydraulic cylinder the manual power to be applied is reduced considerably. Of course, instead of a hydraulic cylinder also a linear motor or an electro-mechanic adjusting unit can be provided. However, as usually hydraulic drives are present in the discussed disintegrating devices, of course, preferably also here a hydraulic cylinder is employed.

The hydraulic cylinder and/or the pivot unit are provided on at least one axis at the machine frame and at another axis at the assembly. This means the hydraulic cylinder engages at the assembly B and is defined at an axis at the machine frame such that it can be swung outwards without any problems. Of course, the hydraulic group is provided such that the disintegrating performance and in particular the removal of the disintegrated material is not impeded by this components.

As already mentioned the common assembly has a module configuration. For example a frame is provided arranged at a part of the wall of the machine frame. It is an advantage here when the frame can be inserted and/or pulled out via a guide at the part of the wall, and can in particular be defined there. Accordingly the frame can either be removed along with the screening device or individually, for example when the screening device has already been removed, and/or when the work is done without screening device. Furthermore, guide ribs are provided on the part of the wall opposite the wall carrying the pivotable assembly. These guide ribs serve for guiding the material to be disintegrated, and correspond in particular with the distance of the screening elements of the screening device when this is provided in the disintegrating device.

For a safe locking of the machine frame a locking unit is provided by means of which the common assembly and/or the part of the machine wall can be defined and/or locked at the machine frame. This locking unit comprises here advantageously locking bolts engaging in locking openings. Accordingly the locking unit comprises the locking bolts as well as the locking openings.

As already mentioned it is an advantage when the screening device as part of a system can be combined with different disintegrating rollers having different diameters such that different disintegrating tasks can be carried out with the disintegrating device. For this reason the screening device is arranged such that it can be moved, in particular be pivoted in addition relatively to the disintegrating roller.

The invention is also characterized in that the disintegrating roller has a mechanical, electric, electro-mechanic, hydraulic drive, or a combustion engine as drive, and/or one drive each is provided for the disintegrating roller, the pivot drive of the screening device as well as for the pivot unit of the assembly. Besides the configuration with one drive each for the different elements of the disintegrating device to be moved, it is, of course, also possible and provided according to the invention that a common drive drives all assemblies, namely drive of the disintegrating roller, pivot drive of the device as well as pivot unit of the assembly.

The position of the disintegrating roller and the screening device is essentially horizontal in the device. The screening device comprises the disintegrating roller in the bottom area, seen in installation direction. It is also an advantage when the screening device, seen in section, encircles the disintegrating roller by about 45-60%, the bottom end of the screening device and the top end forming an angle of 40-60% with respect to the installation plane of the device.

### BRIEF DESCRIPTION OF THE SEVERAL VIEWS OF THE DRAWINGS(S)

In the following the invention will be described further by means of examples. In the figures:

FIG. 1a a disintegrating device according to the invention without screening device with the assembly swung outward,

FIG. 1b The disintegrating device with, a screening device at the pivotable assembly,

FIG. 2 a top view of the representation according to FIG. 1b,

FIG. 3 a top view of the disintegrating device according to the invention with swung-in assembly, and

FIG. 4 the disintegrating device according to the invention in a cut representation with visible pivot unit for the assembly.

### DETAILED DESCRIPTION OF THE INVENTION

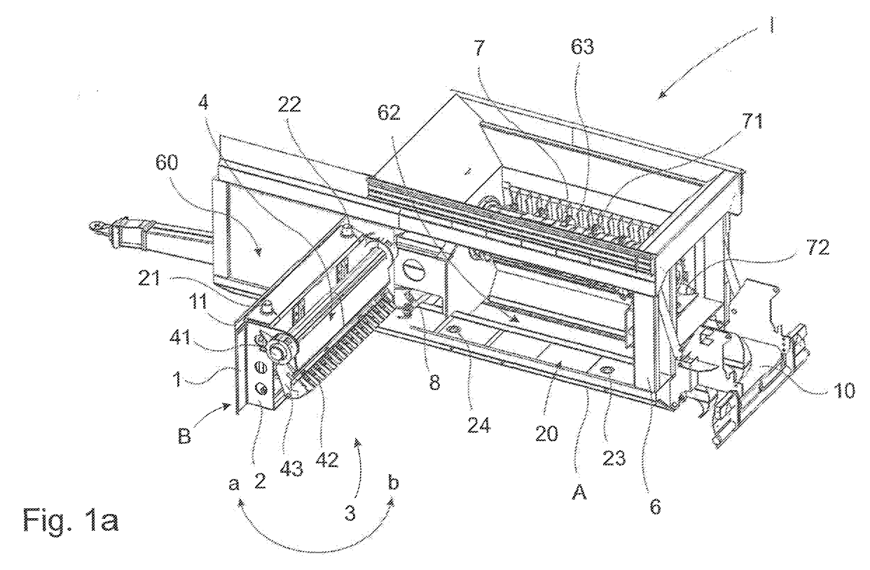

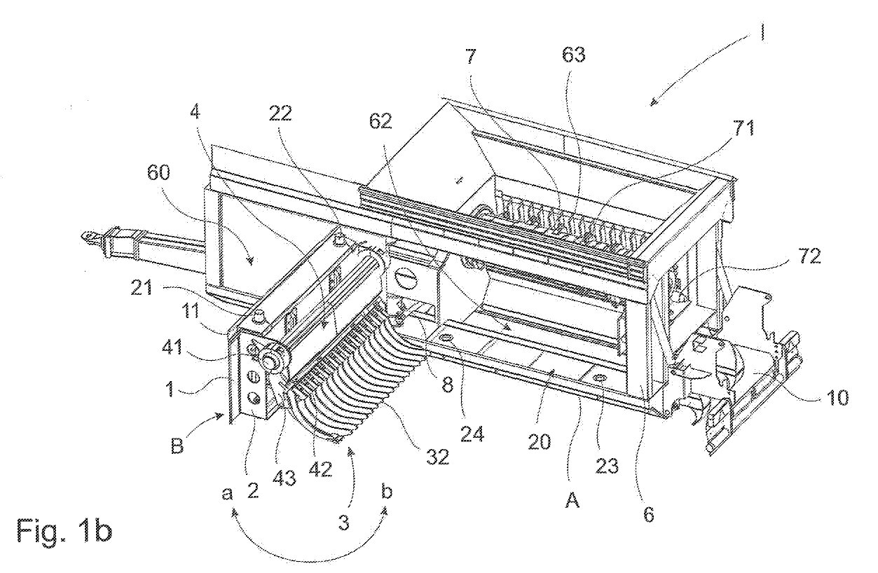

FIG. 1a shows a disintegrating device I according to the invention without screening device with swung-out assembly B. The disintegrating device I and the assembly B are indicated schematically by one arrow each. The machine housing 6 is installed on an installation surface A on the floor and/or an installation plane not indicated in detail. The installation surface A is here the bottom end of the machine housing 6 seen in installation direction. The common assembly B comprises a part of the wall 61 of the machine housing 6 and/or the wall plane 60. The part of the machine wall that cannot be swung out is referred to by wall plane 60. The pivotable assembly B comprises in the representation of FIG. 1 a frame 2 inserted in a part of the wall 61 via a guide 11. A comb carrier 4 where the counter blades 42 are arranged is arranged at the frame 2. Furthermore, a comb carrier shaft 41 is indicated the comb carrier being pivotable thereon. Several counter blades 42 form a counter comb. This counter comb is attached to a joint 43 of the comb carrier 4, the joint 43 being provided also at the comb carrier shaft 41. Furthermore, the common assembly B comprises a locking unit 20 also indicated only schematically by an arrow. The locking unit 20 consists of a locking bolt 21, 22, and the locking openings 23 and 24. The locking openings 23 and 24 are arranged at the machine frame 6, the locking bolts 21 and 22 being arranged at the frame 2 of the pivotable assembly B in the shown embodiment. In addition to that on the wall opposite the pivotable wall 61 guide ribs 63 are provided serving for guiding the material to be disintegrated, and in particular corresponding with the distance of screening elements when a screening device is provided. However, in FIG. 1 a screening device 3 is indicated schematically only by means of an arrow such that it can be arranged at the pivotable assembly B.

The disintegrating roller is referred to by 7, the disintegrating tools being referred to by reference numbers 71. The rotational axis 72 extends in longitudinal direction of the disintegrating roller 7 and/or the machine frame 6. The bottom of the machine frame 6 is indicated by reference number 82. On the right-hand side of the representation a flap is provided, indicated by reference number 10, where, for example, a conveying means can be arranged serving for removing the disintegrated and, if necessary, screened material.

FIG. 1b is provided analogously to FIG. 1a with identical reference numbers for identical technical features. In contrast to the representation shown in FIG. 1a, at the disintegrating device I according to the invention a screening device 3 is arranged at the pivotable assembly B. The screening device 3 comprises here screening elements 32 corresponding in particular—as already mentioned in the description of FIG. 1a—with the guide ribs 63 provided on the part of the wall opposite the wall 61 and/or part of the wall 61. The screening elements are designed pole-like. A bent arrow and the reference numbers a and b at the respective ends of the arrow indicate that the common assembly B is configured pivotable, and this is here at an angle of up to 90° degrees with respect to the rotational axis 72 of the disintegrating roller 7. As it can be seen already in FIG. 1a and accordingly also in FIG. 1b, a part of the hydraulic cylinder 8 serves as pivot unit for the common assembly.

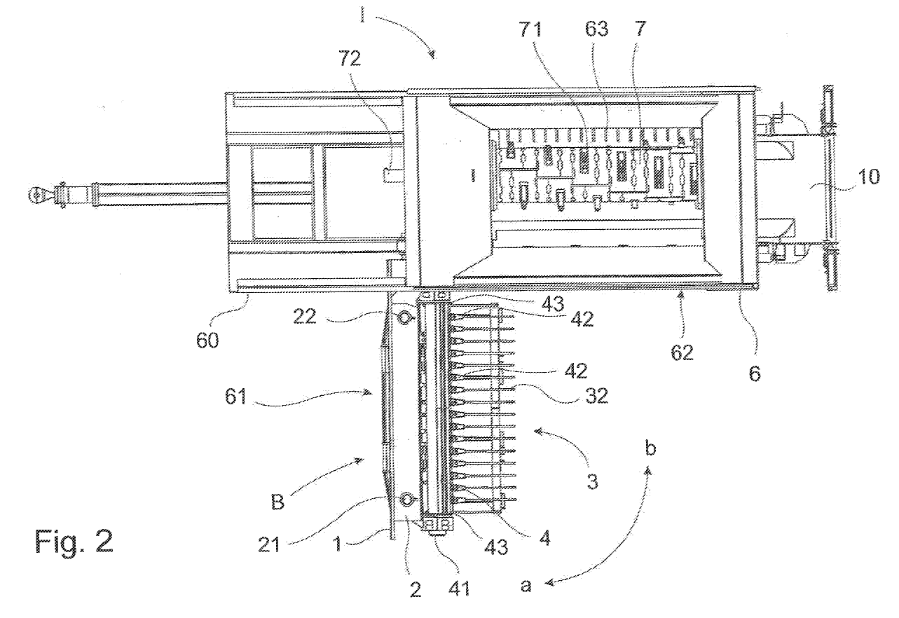

FIG. 2 shows a top view of the representation according to FIG. 1b. Here also the same reference numbers have been used so that a new presentation is not necessary. The pivoting ability a, b is limited here exactly to 90° with respect to the machine axis 72.

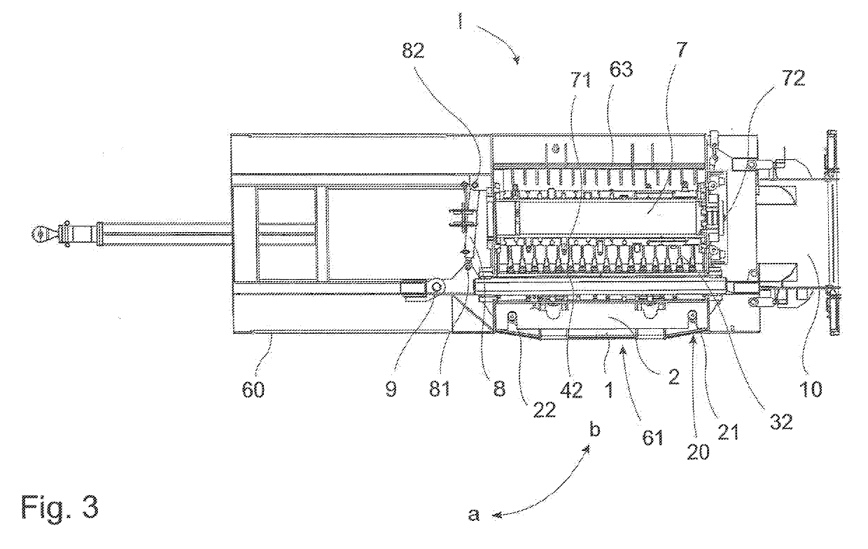

In FIG. 3 the disintegrating device I is also shown in a top view, and this is with the assembly B swung in. The pivot axis 9 for the common assembly B and also the axis 82 for the hydraulic cylinder 8 are indicated. Additionally another axis 81 is shown where the hydraulic cylinder engages at the common assembly B. As it can be seen, a slightly angled position of the hydraulic cylinder 82 with respect to the perpendicular line of the axis of the machine frame and/or the perpendicular line of the axis of the disintegrating roller 72 makes possible a safe and easy swinging-out by means of the hydraulic cylinder 8.

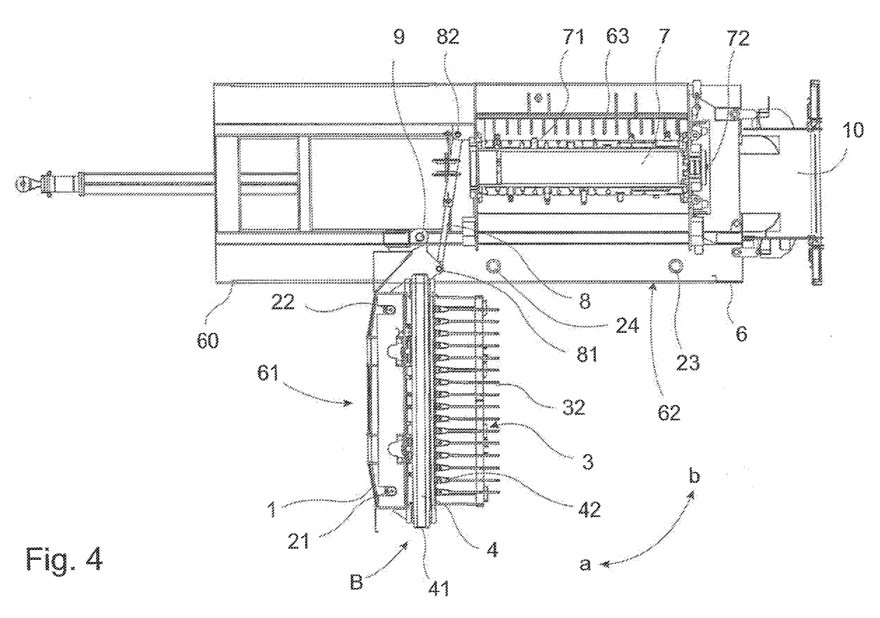

FIG. 4 shows the disintegrating device I according to the invention in a cut representation with visible pivot unit for the common assembly B. This representation shows the swung-out position where, of course, the elements of the pivot unit can be seen even more in detail than, for example, in FIG. 3. The use of reference numbers, however, is as already mentioned uniform in all drawings so that a new description is not necessary here. Reference number 62 indicates the opening in the wall plane 60 and/or the machine frame 6 where the common assembly B and/or the wall 61 can swing in.

The invention has been described before by means of examples. The claims filed now and later on along with the application are attempted formulations without prejudice for obtaining a broader protection.

References in the dependent claims refer to the further design of the matter of the main claim by the characteristics of the respective sub-claim. These are, however, not to be understood as a waiver for obtaining an independent, subjective protection for the characteristics of the referred sub-claims.

Characteristics so far only disclosed in the description may now, in the course of proceedings, be claimed as being of inventive relevance, for example to distinguish from the state of the art.

1. A disintegrating device consisting of a machine housing that can be installed on an installation plane and/or installation surface, at least one disintegrating roller supported rotatably in the machine housing with at least one disintegrating tool arranged thereon, and with at least one counter blade interacting with the disintegrating tool and with at least one comb carrier provided on at least one wall of the machine housing extending parallel to the axis of rotation of the disintegrating roller, wherein at least one part of the wall of the machine housing forms a common in particular pivotable assembly along with the comb carrier.

2. The disintegrating device according to claim 1, wherein the common assembly is supported on a pivot axis and is configured such that it can pivot away from the disintegrating roller and/or the machine frame outward and back inward, wherein preferably the pivot axis is provided and/or arranged orientated vertically, preferably at an angle of 90° with respect to the installation plane and/or the installation surface of the machine frame.

3. The disintegrating device according to claim 1, wherein in that in that the common assembly can pivot outward out of the level of the wall up to an angle of 120°, preferably until 90°, with respect to the rotational axis of the disintegrating roller.

4. The disintegrating device according to claim 1, wherein the common assembly is configured like a module, and preferably comprises the wall, the comb carrier, the counter blade, a frame for the comb carrier as well as a locking unit as modules, and/or the locking unit comprises locking bolts and locking openings.

5. The disintegrating device according to claim 1, wherein the common assembly comprises also a screening device that encircles in the pivoted-in position of the assembly the disintegrating roller at least in sections in a defined, preferably changeable distance.

6. The disintegrating device according to claim 1, wherein the screening device is arranged at the comb carrier, and/or the comb carrier comprises a comb carrier shaft arranged at the frame.

7. The disintegrating device according to claim 1, wherein several counter blades form a counter comb attached to a connecting element of the comb carrier that is again provided at the comb carrier shaft.

8. The disintegrating device according to claim 1, wherein the screening device is arranged at the horizontally orientated comb carrier shaft preferably pivoting along with the connecting element, or the comb carrier releasably fixedly at the frame.

9. The disintegrating device according to claim 1, wherein a pivot unit is provided preferably as hydraulic cylinder pivoting the common assembly in and out over the pivot axis orientated vertically seen in assembly position out of the wall level of the machine frame.

10. The disintegrating device according to claim 1, wherein the hydraulic cylinder engages at least at one axle at the machine frame, and at another axle at the assembly, wherein in particular the frame can be inserted and/or pulled out via a guide at the part of the wall, and can in particular be defined there.

11. The disintegrating device according to claim 1, wherein the guide ribs are provided on the side of the machine frame opposite the part of the wall serving for guiding the material to be disintegrated, corresponding in particular with the distance of the screening elements of the screening device.

12. The disintegrating device according to claim 1, wherein the screening device as part of the system can be combined with different disintegrating rollers with differing diameters such that different disintegrating tasks can be performed with one disintegrating device.

13. The disintegrating device according to claim 1, wherein the screening device additionally is arranged, in particular pivoting, relatively to the disintegrating roller, and/or the screening device encircles the disintegrating device by about 45 to 60 percent seen in section, the bottom end of the screening device and the top section form an angle of 40 to 60 degrees with respect to the installation plane of the device.

14. The disintegrating device according to claim 1, wherein the disintegrating roller has a mechanical, electric, electro-mechanical, hydraulic drive or a combustion engine as drive, and/or one drive each is provided for the disintegrating roller, the pivot drive of the screening device as well as for the pivot unit of the assembly.

15. The disintegrating device according to claim 1, wherein the position of the disintegrating roller and the screening device is orientated in the device essentially horizontally and/or parallel to the installation plane and/or installation surface and/or the screening device encircles the disintegrating roller in the bottom area in installation direction.
